(19) United States
(12) Patent Application Publication
(10) Pub. No.: US 2012/0150925 A1
(43) Pub. Date: Jun. 14, 2012

(54) Proactive Method for Improved Reliability for Sustained Persistence of Immutable Files in Storage Clouds

(75) Inventors: Shweta Gupta, Pune (IN); Abhinay R. Nagpal, Pune (IN); Pamela A. Nesbitt, Durham, NC (US); Sandeep R. Patil, Somers, NY (US)

(73) Assignee: INTERNATIONAL BUSINESS MACHINES CORPORATION, Armonk, NY (US)

(21) Appl. No.: 12/964,780

(22) Filed: Dec. 10, 2010

(51) Int. Cl. G06F 17/30

(52) U.S. Cl. 707/822; 707/E17.005

(57) ABSTRACT

Embodiments are disclosed for storing an immutable file in cloud disk space determined to be suitable for the length of time the file specified to be maintained. This is done by detecting the immutable status of a data file to be saved and determining an expiry date of said immutable file. The available cloud storage space is analyzed to determine suitable storage locations, and the immutable data file is stored in the location determined to be optimal that accommodates the expiry date of the immutable file.

### BACKGROUND

1. Technical Field

Various embodiments of the present invention relate to computers, and more specifically, to computer storage.

2. Description of Related Art

It is often important to keep certain files and data for a given length of time. Such data retention requirements often come from compliance-governed industries including regulatory agencies, the financial services sector, and the health care sector. There are various regulations in healthcare and the financial services sector like HIPAA and requirements of the Federal Financial Institutions Examination Council (FFIEC) that mandate immutable persistence of a certain files. For example, HIPAA's Security Rule (Technical Safeguard section) requires that the security logs of incidences are to be preserved for at least six years in an immutable fashion. Various requirements of the HIPAA act mandate the preservation of electronic protected health information (ePHI) documents as well as audit logs in a tamper-proof fashion for a given number of years.

Some conventional file systems and storage applications allow documents and files to be marked as immutable. Marking files or data as immutable indicates that the content of the files as well as the file itself should not be deleted or modified for a given amount of time or until some criterion is met. However, no further provision is made, other than marking the files as immutable, to ensure the files are safely retained for the requisite retention period.

### BRIEF SUMMARY

Various embodiments involve methods, computer products and systems for storing immutable files in cloud storage locations deemed suitable. Upon detecting an immutable file, the system determines the files expiry date and then analyzes the available cloud storage space to determine one or more suitable storage locations. The immutable file is then stored in the optimal suitable storage location that can accommodate the expiry date of the immutable data file.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 is a flowchart of a method for setting up and using various embodiments;

FIG. 2 is a flowchart of a method for directing immutable files to suitable storage locations according to various embodiments;

FIG. 3 depicts an example architecture of an immutable file system according to various embodiments; and

FIG. 4 is depicts a computer system suitable for implementing and practicing the various embodiments.

### DETAILED DESCRIPTION

A file is marked immutable generally has an associated expiry time or condition for removing the immutable status. Marking a file immutable typically indicates the file is of high importance or critical value, at least for the specified period of time. Hence, it is vital to reliably preserve the file. Release V3.3 of IBM's strategic clustered file system, the General Parallel File System (GPFS), allows files to be marked immutable, indicating that they should not be changed or deleted by any user for a given amount of time. However, preserving an immutable file may entail handling the file in a special manner if the file is not initially stored in a suitable location. With hybrid storage becoming increasingly prevalent, it can be difficult to initially store an immutable file in a suitable storage location. This increases the chances that the data will either be lost, or need to be moved, before reaching the immutable file expiry date.

Hybrid storage is becoming increasingly common with the advent of flash solid state drive (SSD) memory and its advantages over hard disk drive (HDD) memory. Other emerging memory technologies may result in an even wider range of cloud storage characteristics. For example, the advent of Phase Change memory and Racetrack technology based disks may further increase the hybrid nature of cloud storage. As a result, different storage locations and disks may begin to vary in their reliability, features, costs, and other characteristics, depending upon the underlying technology of the disks. This, in turn, gives rise to the need for administrators to make judicious use of these disks—that is, if the underlying storage technology is known. For example, Flash based disks come with faster seek time but are costlier compared to HDD. Similarly, in the future, racetrack based disk may become more reliable than traditional HDD storage. Hybrid storage with disks of varying base technologies and characteristics are likely to be common in the coming years.

Storage clouds, both public and private, often span storage farms consisting of hybrid disks. Some of the storage cloud disks will be Flash based while others are HDD. Some disks will likely be based on Phase-Change (PC) technology, and perhaps some on Racetrack (RT). This trend will most likely become more apparent in coming years. Each different type of these disks will have different characteristics as each is based on different technology science. Some of these will be more reliable than the others, and some of them will be more suitable for long term data preservation. Since storage clouds will span across various storage farms, there will be disks of different ages as well as different technologies. Typically, clustered file systems like IBM's GPFS are used to manage data over storage farms. Such file systems stripe the data across the disks. Often, a single file data will be striped across multiple disks.

The present inventors recognized that none of the conventional storage systems or clustered file systems used in storage proactively analyze the blocks allocated to a file. Hence, there is a need to ensure that files marked as immutable are stored on a disk whose average current life (e.g., as derived from its specification) is greater than the immutable expiry date of the file. For files stored in hybrid storage farms, the various embodiments ensure that the blocks associated with immutable files reside on a disk of the technology type (e.g., HDD/SSD/Racetrack) which is sufficiently reliable for the expiry date and criticality of the data.

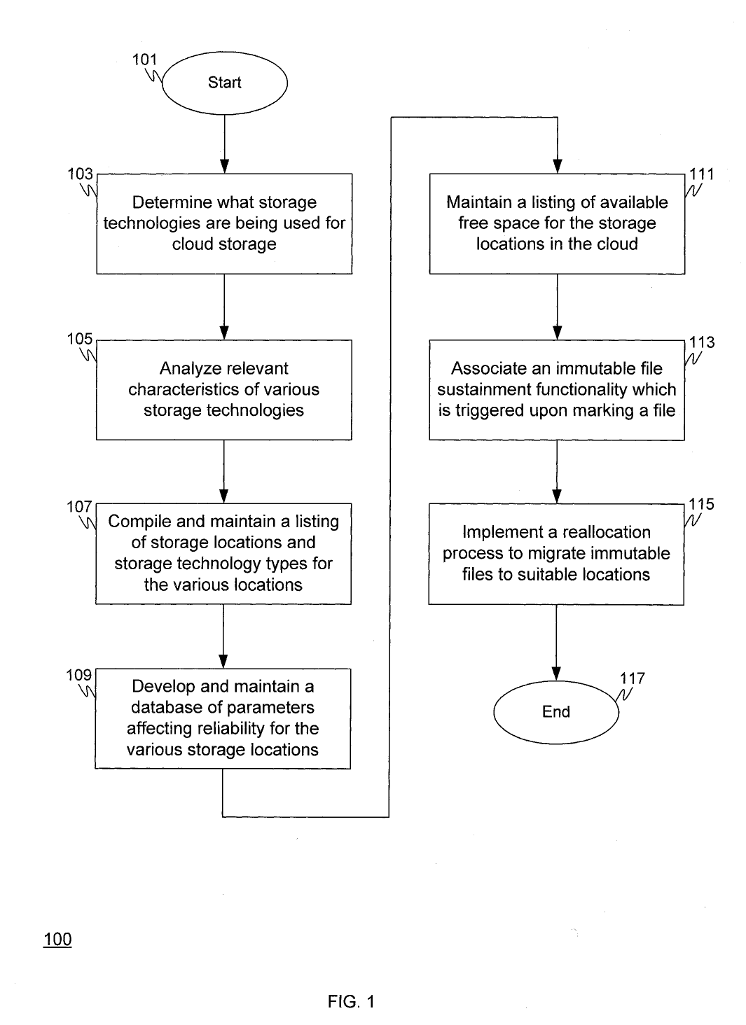

FIG. 1 is a flowchart of a method for setting up and using various embodiments. The method begins at block 101 and proceeds to 103 to determine what storage technologies are being, or to be, used for the cloud storage. The system may employ of SSD and HDD memories as well as Phase Change memory and possibly Racetrack technology based disks, or other like storage technologies. Block 103 may entail an ongoing effort as new, emerging memory technologies are developed and come on-line in the cloud. Once the various storage technologies have been identified in 103 the method proceeds to 105.

In block 105 the relevant characteristics of the various storage technologies are analyzed and recorded. This may entail studying the specifications and published reviews of the different memory technologies in general, as well as specific name brands and models in particular. Block 105 may also entail the gathering of empirical data of relevant characteristics. For example, studies may show Flash based disk storage to be more reliable than an HDD in hybrid storage, while racetrack will be yet more reliable than Flash. The relevant characteristics typically include the parameters and factors that determine or affect reliability (e.g., the odds of data loss for a given age/usage level of the equipment), expected life of the disk, cost, or other like characteristics. Once the relevant characteristics have been considered each technology is assigned an immutability rating. An example of such an immutability rating is provided in the table below.

TABLE 1

| | Rating |
|---|---|
| Disk Technology | (1 = best; 5 = worst) |
| Racetrack | 1 |
| Phase Change | 2 |
| Flash | 3 |
| HDD | 4 |

The immutability rating for various storage technologies may be a numerical ranking showing the order of the technologies, as shown in Table 1, or may be a rating base on a scale that grades the technologies according to their parameters. For example, the scale may be a percentile scale of 1 to 99, showing the relative effectiveness of the various technologies for storing immutable files. Furthermore, cost can be one of the factors calculated in the scale (or the ranking). Once the equipment characteristics have been analyzed and recorded in block 105 the method proceeds to 107.

Block 107 involves compiling and maintaining a listing of the storage locations—e.g., disks—to be used in the cloud storage scheme, along with the type of storage technology at each location. Knowing this information allows the system to make an informed decision as to where best to store a given data file, in view of its expiry date and criticality status. Upon completing block 107 the method proceeds to 109 to develop and maintain a database of parameters affecting reliability for the various storage locations. One such parameter may be the age of particular disk units available to receive data for storage. Another parameter may be the usage level of the disk units inasmuch as disks experiencing greater usage may be more susceptible to wear and failure. The system may determine and track the age and usage level for use in calculating an expected remaining life for particular disks, in view of the expected life of the disk and other parameters gathered in 105.

Upon completing block 107 the method proceeds to 109 to gather disk attributes for the disks to be used in cloud storage. This may involve gathering disk reliability factors including data and parameters for given disk locations, and particular servers and disks. This data and parameters is similar in nature to the information of Table 1, except it is aimed at helping to estimate the reliability of particular disks and servers rather than entire storage technology types. The data and parameters may be in various forms, including for example, the manufacturing date of the disks, the current age of the disks (e.g., age since installation), usage parameters for the disks, the health of the disk (e.g., derived from Self-Monitoring, Analysis, and Reporting Technology (SMART) parameters), the end-of-life date of the disks, (e.g., derived and calculated from the disks' specifications, health of the disks, and number of hours of usage fetched from SMART parameters), the disks' technology type, and/or other such parameters affecting the reliability and expected life of particular disks, servers, or storage sites.

The disk reliability factors the mean time between failure for the disk locations, or other data or parameters indicating the disk location's reliability. This may involve obtaining the data and parameters, or monitoring the locations over long periods of time, or collecting past reliability data from available sources. Reliability data may also be gathered for entire server farms, or sectors of the server farms. Certain locations—that is, geographic locations—may be relatively more susceptible to failure due to weather conditions, communication line failures overload conditions, or other factors specific to that particular server farm or location within the cloud. The method then proceeds to 111 to develop and maintain a listing of available free space in which data may possibly be stored within the cloud. It is anticipated that the free space will include storage space suing multiple different storage technologies such as HDD, SSD, Racetrack, Phase Change memory, or other like storage technologies know to those of ordinary skill in the art.

Once the reliability data and parameters for the disk locations has been obtained in 109 the method proceeds to 111 to determine and maintain the free memory pool available across the storage cloud for various technology types. Block 111 involves maintaining a listing of available free space for the various storage locations to be used in the cloud, for example, as shown in Table 2. Maintaining this listing allows the system, or the administrators running the system, to know where there is available capacity to store data files. Since data and files are constantly being stored and deleted the available storage capacity should be updated from time to time or at periodic intervals.

TABLE 2

| | Available Free Space |
|---|---|
| Disk Technology | Across Cloud |
| Racetrack | 200 GB |
| Phase Change | 100 GB |
| Flash | 250 GB |
| HDD | 500 GB |

Upon completing the listing of available free space in 111 the method proceeds to block 113 to associate immutable file sustainment functionality with the strategic clustered file system, e.g., the GPFS.

The immutable file sustainment functionality can be triggered by marking a file as immutable. In some embodiments files or data may become immutable through other means as well, such as meeting an immutability condition or criteria. For example, the files associated with a given criteria (e.g., files of a particular client, a hospital patient, or a given financial transaction) may become immutable when an immutability condition it met. One example of an immutability condition occurs in result to a regulatory agency declaring that an investigation or audit is being undertaken. Another example of an immutability condition may occur in response to a particular matter or issue becoming involved in a lawsuit. When an immutability condition is met the files and data associated with the matter or issue are elevated to an immutable status. In this way, the files or data cannot surreptitiously be deleted, or otherwise be lost.

Block 115 of FIG. 1 involves the implementation of the immutable file sustainment system. Once the system has been set up and the various databases and listings have been gathered in steps 103-113 the functionality can be enabled to implement the system. Upon implementing the immutable file sustainment system the method proceeds from block 115 to 117 and ends.

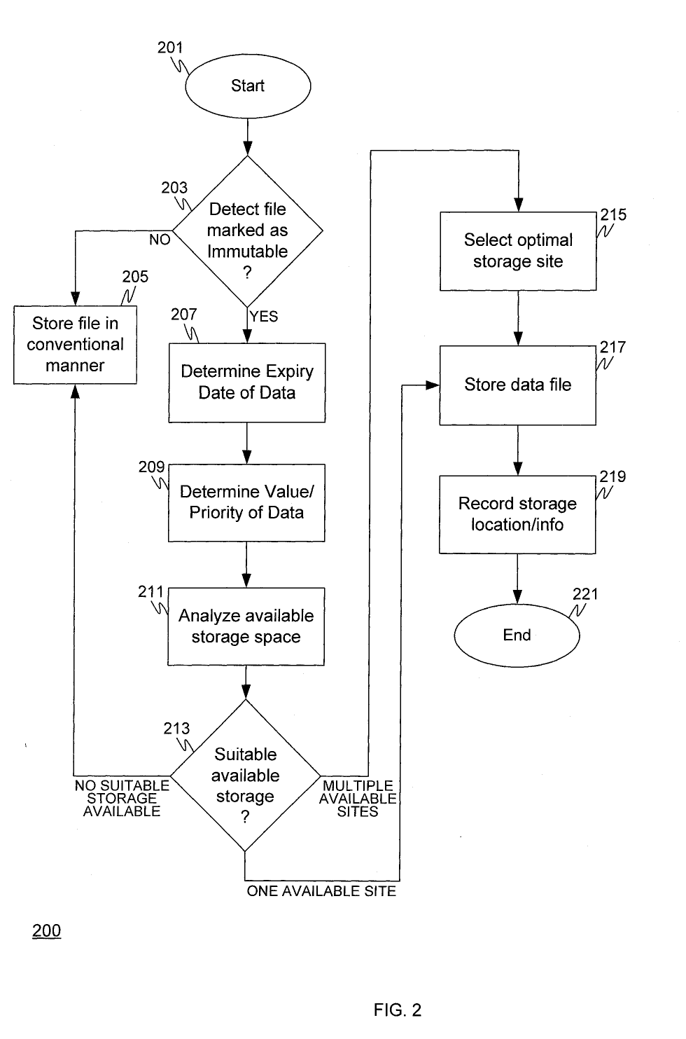

FIG. 2 is a flowchart of a method for directing immutable files to suitable storage locations according to various embodiments. The method begins in block 201 and proceeds to 203 to determine whether a file is marked as immutable. A file may be “marked” as immutable either by identifying or administrative data within the file itself (e.g., header data, or the like), or by identifying or administrative data associated with the file (e.g., a list or database of file statuses specifying certain files as immutable). In some instances this determination is made in response to a file being created, or saved from another location. In other instances, a change in circumstance may result in the immutability status of a file being changed to an immutable status, e.g., the medical records of a patient may become immutable upon a complication developing in the patient's treatment, or certain law firm records may attain a status of immutable in response to a litigation being filed. In yet other circumstances a file may become immutable in response to an audit being performed on the files, or in response to a review of existing files, e.g., at the time the present system for improved reliability of immutable files cloud storage is implemented for an existing data storage system. If it is determined in block 203 that the file is not marked as immutable then the method proceeds along the “NO” path to 205 to store the file in a conventional manner. If it is determined in block 203 that the file is marked as immutable the method proceeds from 203 along the “YES” path to 207.

Block 207 determines the expiry date for the file, or whether any expiry date exists for the file. An expiry date is the date at which the immutability status of the file changes. In some instances the file may cease to be immutable at the expiry date. In other instances the status may change to a lesser degree of immutability. For example, during a governmental investigation certain records might be marked as immutable with instructions to permanently maintain the records, that is, to prevent destruction of the records until such time as the status is lowered or removed. At a later date, upon exoneration of the party being investigated, these same records may have their immutability status lowered to a finite expiry date (e.g., maintain records for 10 years) rather than an immutability status requiring permanent data retention. Returning to block 207, once the expiry date of the data is determined the method proceeds to 209.

Block 209 determines an indication of data priority. Depending upon the circumstances, various types of data can have a wide range of values and priority. For example, the files containing video from an automated teller machine (ATM) may be of little value during the course of an ordinary day. Such data may be discarded after a short time, say, one week. However, data from the same ATM may be elevated to have a high priority if the camera records a crime taking place. In other instances there may be a penalty associate with destruction of certain data files. For example, a district attorney may be bound by an ethical duty, or even a statutory requirement, to turn over exculpatory evidence to the defendant's attorney (e.g., evidence favorable to the defendant, or tending to provide the innocence of the defendant). The destruction of files containing exculpatory evidence may violate certain statutes or ethical requirements. Once the data values and/or priority is determined in block 209 the method proceeds to 211.

Block 211 of FIG. 2 entails analyzing the storage space available in the cloud storage scheme. The cloud storage space is evaluated to determine whether suitable storage space is available for the data. This may entail determining whether there is available storage space that can accommodates the expiry date of the data file—that is, whether there are disks available with an expected remaining life that exceeds the expiry date of the data file. It may be the case that the expiry date is exceeded by more than one disk technology, and by a great number of cloud storage locations. It should be noted that the installation date is an important consideration in addition to the expected life of the disk technology. Existing disks within the cloud will only have a portion of their expected life remain, depending upon how long ago the disk was installed, the usage level of the disk, and other factors affecting the disk's expected life. The older installations of the highest quality, longest lived technology may have relative short expected lives if a significant portion of their life has been used up since installation. Block 211 may result in a ranking of available cloud storage sites based on suitability, say, the top 20 sites ranked from most to least suitable based on the selected criteria for storing the data. Once block 211 is completed and the available disk space in the cloud has been analyzed the method proceeds to 213.

In the event it is determined in 213 that there is no suitable storage space available in the cloud then the method proceeds from 213 to block 205 to store the data in a conventional manner. If it is determined in 213 that there is only one available storage site deemed acceptable then the method proceeds from 213 to block 217 to store the data in that one site. However, if block 213 determines that multiple sites would be suitable for storing the data then the method proceeds from 213 along the “multiple sites” path to 215. In block 215 the system selects the optimal available cloud site for storing the data. The optimal site may be based on the evaluation of storage site suitability performed in block 211. The evaluation may take into consideration any factors or parameters deemed important, either by the user (e.g., owner of the data or administrator of the system) or by the logic of the system itself. Such factors and parameters may include the disk technology, the cost of the storage site, the expected reliability, the remaining life of the disk, the extent to which the disk end-of-life matches (or exceeds) the expiry date, the accessibility time for the disk, the security clearance of the storage facility (e.g., Department of Defense (DoD) security clearance or other governmental agency security clearance), the parties having access to the data (e.g., the cloud storage site is not a competitor of the data owner), and other like factors or parameter known to those of ordinary skill in the art that may affect the suitability of various cloud storage sites or disks.

Once the optimal storage site has been selected in 215 the method proceeds to 217. In block 217 the data file is stored on the selected disk in the cloud. In the event the system specifies a redundant storage location (or multiple redundant storage locations) the data file will be stored in the multiple selected locations at this time. Once the file has been saved the method proceeds to block 219. In 219 the location (or locations) in the cloud are stored along with relevant information. This information may include the disk's address information, installation date, cumulative usage levels to date, downtime history, and any other relevant information needed to retrieve the data or monitor its security as would be known by those of ordinary skill in the art. Once the relevant information has been recorded in 219 the method proceeds to 221 and ends.

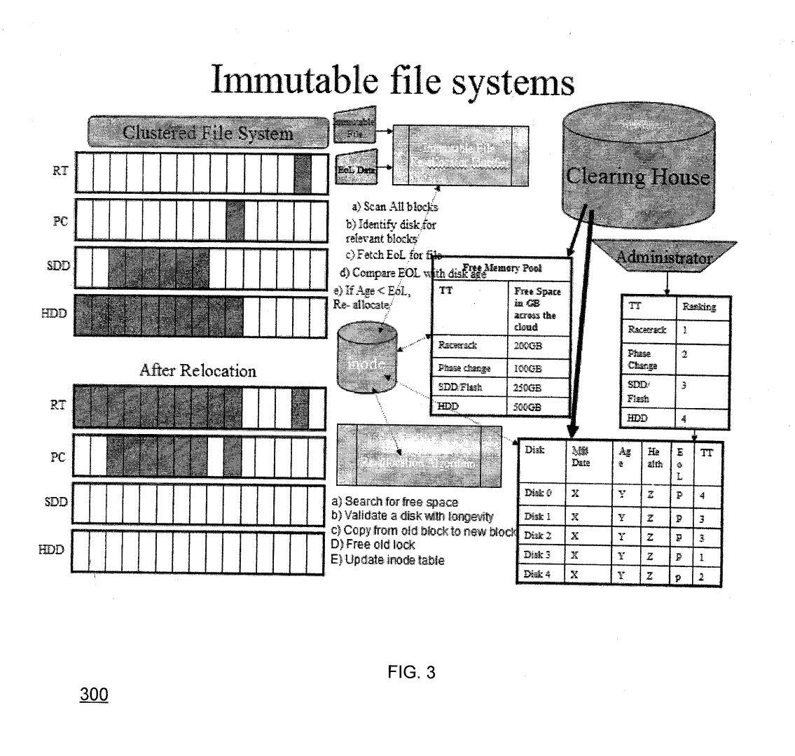

FIG. 3 depicts an example architecture of an immutable file system according to various embodiments. As shown in the figure under “Clustered File System” the files are initially distributed across several technology types without consideration for whether or not the files are immutable. The disk technologies of this example include: RT (racetrack), PC (phase change), SDD (solid state disk, or flash) and HDD (hard disk drive). Other disk technologies may be used as well. After scanning the blocks of the disks for stored data the data files are reallocated across the various disk technologies to locations suitable for the immutable files. That is, to disk locations characterized by an end of life (EoL) beyond the expiry date of the immutable data files. The process of reallocating the immutable data files may be achieved in the manner described above in conjunction with FIGS. 1 and 2.

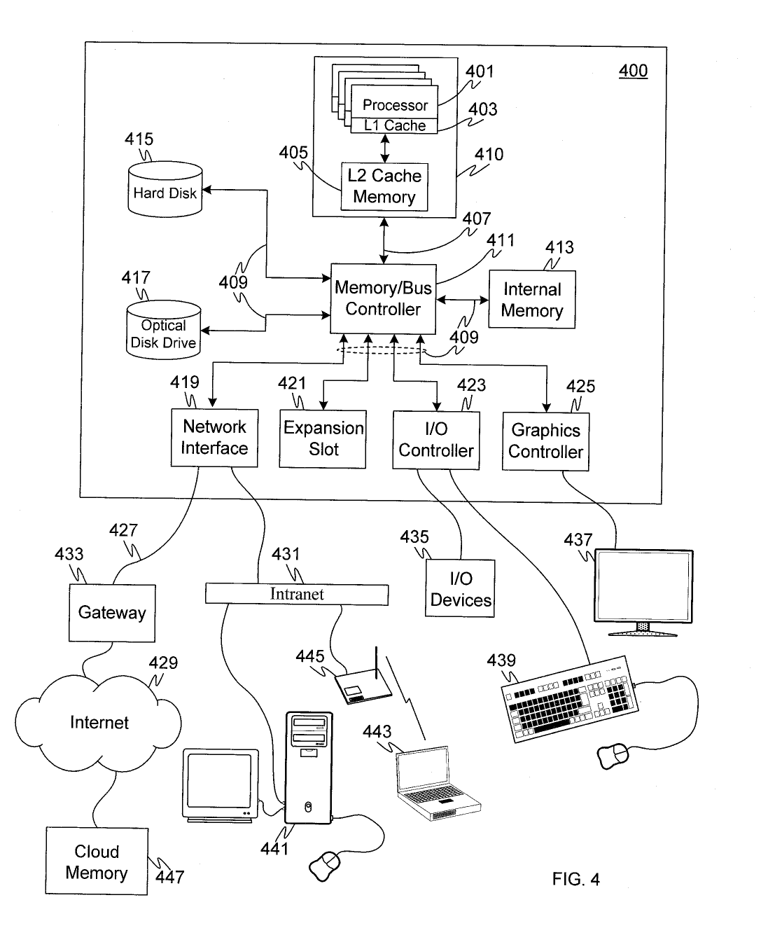

FIG. 4 depicts a computer system 400 and components suitable for implementing the various embodiments disclosed herein. The computer system 400 may be configured in the form of a desktop computer, a laptop computer, a mainframe computer, or any other hardware or logic arrangement capable of being programmed or configured to carry out instructions. In some embodiments the computer system 400 may act as a server, accepting inputs from a remote user over a local area network (LAN) 427, the Internet 429, or an intranet 431. In other embodiments, the computer system 400 may function as a smart user interface device for a server on the LAN 427 or over the Internet 429. The computer system 400 may be located and interconnected in one location, or may be distributed in various locations and interconnected via communication links such as a LAN 427 or a wide area network (WAN), via the Internet 429, via the public switched telephone network (PSTN), a switching network, a cellular telephone network, a wireless link, or other such communication links. Other devices may also be suitable for implementing or practicing the embodiments, or a portion of the embodiments. Such devices include personal digital assistants (PDA), wireless handsets (e.g., a cellular telephone or pager), and other such electronic devices preferably capable of being programmed to carry out instructions or routines. Those of ordinary skill in the art may recognize that many different architectures may be suitable for the computer system 400, although only one typical architecture is depicted in FIG. 4.

The computer system 400 is connected to storage cloud memory 447 via the Internet 429, or via another network or communication link. The storage cloud 447 may be either public or private, and may span multiple storage farms consisting of hybrid disks. Some of the storage cloud disks may be flash based solid state drive (SSD), while others are hard disk drive (I-IDD) memory, phase change (PC) technology, or racetrack (RT) memory technology. Any combination of one or more non-transitory computer readable storage disks of these or other technologies may be used in the cloud storage. In some embodiments the computer system 400 may be connected directly to the cloud storage disks 447 rather than via the Internet 429, or connected directly to a portion of the disks and connected via the Internet or other network to the remainder of the cloud storage disks 447.

Computer system 400 may include a processor 401 which may be embodied as a microprocessor, two or more parallel processors as shown in FIG. 4, a central processing unit (CPU) or other such control logic or circuitry. The processor 401 may be configured to access a local cache memory 403, and send requests for data that are not found in the local cache memory 403 across a cache bus to a second level cache memory 405. Some embodiments may integrate the processor 401, and the local cache 403 onto a single integrated circuit and other embodiments may utilize a single level cache memory or no cache memory at all. Other embodiments may integrate multiple processors 401 onto a single die and/or into a single package. Yet other embodiments may integrate multiple processors 401 with multiple local cache memories 403 with a second level cache memory 405 into a single package 410 with a front side bus 407 to communicate to a memory/bus controller 411. The memory/bus controller 411 may accept accesses from the processor(s) 401 and direct them to either the internal memory 413 or to the various input/output (I/O) busses 409. Some embodiments of the computer system 400 may include multiple processor packages 410 sharing the front-side bus 407 to the memory/bus controller. Other embodiments may have multiple processor packages 410 with independent front-side bus connections to the memory/bus controller. The memory bus controller may communicate with the internal memory 413 using a memory bus 409.

The internal memory 413 may include one or more of random access memory (RAM) devices such as synchronous dynamic random access memories (SDRAM), double data rate (DDR) memories, or other volatile random access memories. The internal memory 413 may also include non-volatile memories such as electrically erasable/programmable read-only memory (EEPROM), NAND flash memory, NOR flash memory, programmable read-only memory (PROM), read-only memory (ROM), battery backed-up RAM, or other non-volatile memories. In some embodiments, the computer system 400 may also include 3^{rd} level cache memory or a combination of these or other like types of circuitry configured to store information in a retrievable format. In some implementations the internal memory 413 may be configured as part of the processor 401, or alternatively, may be configured separate from it but within the same package 410. The processor 401 may be able to access internal memory 413 via a different bus or control lines than is used to access the other components of computer system 400.

The computer system 400 may also include, or have access to, one or more hard drives 415 (or other types of storage memory) and optical disk drives 417. Hard drives 415 and the optical disks for optical disk drives 417 are examples of machine readable (also called computer readable) mediums suitable for storing the final or interim results of the various embodiments. The optical disk drives 417 may include a combination of several disc drives of various formats that can read and/or write to removable storage media (e.g., CD-R, CD-RW, DVD, DVD-R, DVD-W, DVD-RW, HD-DVD, Blu-Ray, and the like). Other forms or computer readable media that may be included in some embodiments of computer system 400 include, but are not limited to, floppy disk drives, 9-track tape drives, tape cartridge drives, solid-state drives, cassette tape recorders, paper tape readers, bubble memory devices, magnetic strip readers, punch card readers or any other type or computer useable or machine readable storage medium.

The computer system 400 may either include the hard drives 415 and optical disk drives 417 as an integral part of the computer system 400 (e.g., within the same cabinet or enclosure and/or using the same power supply), as connected peripherals, or may access the hard drives 415 and optical disk drives 415 over a network, or a combination of these. The hard drive 415 often includes a rotating magnetic medium configured for the storage and retrieval of data, computer programs or other information. In some embodiments, the hard drive 415 may be a solid state drive using semiconductor memories. In other embodiments, some other type of computer useable medium may be used. The hard drive 415 need not necessarily be contained within the computer system 400. For example, in some embodiments the hard drive 415 may be server storage space within a network that is accessible to the computer system 400 for the storage and retrieval of data, computer programs or other information. In some instances the computer system 400 may use storage space at a server storage farm, or like type of storage facility, that is accessible by the Internet 429 or other communications lines. The hard drive 415 is often used to store the software, instructions and programs executed by the computer system 400, including for example, all or parts of the computer application program for carrying out activities of the various embodiments.

The communication link 409 may be used to access the contents of the hard drives 415 and optical disk drives 417. The communication links 409 may be point-to-point links such as Serial Advanced Technology Attachment (SATA) or a bus type connection such as Parallel Advanced Technology Attachment (PATA) or Small Computer System Interface (SCSI), a daisy chained topology such as IEEE-1394, a link supporting various topologies such as Fibre Channel, or any other computer communication protocol, standard or proprietary, that may be used for communication to computer readable medium. The memory/bus controller may also provide other I/O communication links 409. In some embodiments, the links 409 may be a shared bus architecture such as peripheral component interface (PCI), microchannel, industry standard architecture (ISA) bus, extended industry standard architecture (EISA) bus, VERSAmoduleEurocard (VME) bus, or any other shared computer bus. In other embodiments, the links 409 may be a point-to-point link such as PCI-Express, HyperTransport, or any other point-to-point I/O link. Various I/O devices may be configured as a part of the computer system 400.

In many embodiments, a network interface 419 may be included to allow the computer system 400 to connect to a network 427 or 431. Either of the networks 427 and 431 may operate in accordance with standards for an IEEE 802.3 Ethernet network, an IEEE 802.11 Wi-Fi wireless network, or any other type of computer network including, but not limited to, LANs, WAN, personal area networks (PAN), wired networks, radio frequency networks, powerline networks, and optical networks. A network gateway 433 or router, which may be a separate component from the computer system 400 or may be included as an integral part of the computer system 400, may be connected to the networks 427 and/or 431 to allow the computer system 400 to communicate with the Internet 429 over an internet connection such as an asymmetric digital subscriber line (ADSL), data over cable service interface specification (DOCSIS) link, T1 or other internet connection mechanism. In other embodiments, the computer system 400 may have a direct connection to the Internet 429. The computer system 400 may be connected to one or more other computers such as desktop computer 441 or laptop computer 443 via the Internet 429, an intranet 431, and/or a wireless node 445. In some embodiments, an expansion slot 421 may be included to allow a user to add additional functionality to the computer system 400.

The computer system 400 may include an I/O controller 423 providing access to external communication interfaces such as universal serial bus (USB) connections, serial ports such as RS-232, parallel ports, audio in and audio out connections, the high performance serial bus IEEE-1394 and/or other communication links. These connections may also have separate circuitry in some embodiments, or may be connected through a bridge to another computer communication link provided by the I/O controller 423. A graphics controller 425 may also be provided to allow applications running on the processor 401 to display information to a user. The graphics controller 425 may output video through a video port that may utilize a standard or proprietary format such as an analog video graphic array (VGA) connection, a digital video interface (DVI), a digital high definition multimedia interface (HDMI) connection, or any other video connection. The video connection may connect to display 437 to present the video information to the user.

The display 437 may be any of several types of displays or computer monitors, including a liquid crystal display (LCD), a cathode ray tube (CRT) monitor, on organic light emitting diode (OLED) array, or other type of display suitable for displaying information for the user. The display 437 may include one or more light emitting diode (LED) indicator lights, or other such display devices. Typically, the computer system 400 includes one or more user input/output (I/O) devices such as a keyboard and mouse 439, and/or other means of controlling the cursor represented including but not limited to a touchscreen, touchpad, joystick, trackball, tablet, or other device. The user I/O devices 435 may connect to the computer system 400 using USB interfaces or other connections such as RS-232, PS/2 connector or other interfaces. Various embodiments include input devices configured to accept an input from a user and/or provide an output to a user. For example, some embodiments may include a webcam (e.g., connect via USB), a microphone (e.g., connected to an audio input connection), and/or speakers (e.g., connected to an audio output connection). The computer system 400 typically has a keyboard and mouse 439, a monitor 437, and may be configured to include speakers, microphone, and a webcam. These input/output devices may be used in various combinations, or separately, as means for presenting information to the user and/or receiving information and other inputs from a user to be used in carrying out various programs and calculations. Speech recognition software may be used in conjunction with the microphone to receive and interpret user speech commands.

The computer system 400 may be suitable for use in identifying critical web services and dynamically relocating them to a new server. For example, the processor 401 may be embodied as a microprocessor, microcontroller, DSP, RISC processor, two or more parallel processors, or any other type of processing unit that one of ordinary skill would recognize as being capable of performing or controlling the functions, steps, activities and methods described herein. A processing unit in accordance with at least one of the various embodiments can operate computer software programs stored (embodied) on computer-readable medium such those compatible with the disk drives 415, the optical disk drive 417 or any other type of hard disk drive, floppy disk, flash memory, ram, or other computer readable medium as recognized by those of ordinary skill in the art.

As will be appreciated by those of ordinary skill in the art, aspects of the various embodiments may be embodied as a system, method or computer program product. Accordingly, aspects of the present invention may take the form of an entirely hardware embodiment, an entirely software embodiment (including firmware, resident software, micro-code, or the like) or an embodiment combining software and hardware aspects that may all generally be referred to herein as a “circuit,” “module,” “logic” or “system.” Furthermore, aspects of the various embodiments may take the form of a computer program product embodied in one or more computer readable medium(s) having computer readable program code stored thereon.

Any combination of one or more non-transitory computer readable medium(s) may be utilized. The computer readable medium is typically a computer readable storage medium. A computer readable storage medium may be embodied as, for example, an electronic, magnetic, optical, electromagnetic, infrared, or semiconductor system, apparatus, or device, or other like storage devices known to those of ordinary skill in the art, or any suitable combination of the foregoing. Examples of such computer readable storage medium include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations and aspects of the various embodiments may be written in any combination of one or more programming languages, including an object oriented programming language such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus, systems, and computer program products according to various embodiments disclosed herein. It will be understood that blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, a programmable data processing apparatus, or other such devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur in an order other that that depicted in the figures. For example, two blocks shown in succession may, in fact, be executed substantially concurrently, or the blocks and activities of the figures may sometimes be executed in reverse order or in a different order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “obtaining”, as used herein and in the claims, may mean either retrieving from a computer readable storage medium, receiving from another computer program, receiving from a user, calculating based on other input, or any other means of obtaining a datum or set of data. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The corresponding structures, materials, acts, and equivalents of all means or step plus function elements in the claims below are intended to include any structure, material, or act for performing the function in combination with other claimed elements as specifically claimed. The proposed implementation is explained in terms of using clustered file systems, but a person of ordinary skill in the art would appreciate that it can be mapped to any file systems or storage systems that implements immutable features.

The description of the present invention has been presented for purposes of illustration and description, but is not intended to be exhaustive or limited to the invention in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated.

What is claimed is:

1. A method of storing an immutable file, the method comprising:
detect the immutable file;
determine an expiry date of said immutable file;
analyze available storage space to determine a suitable storage location; and
store the immutable file in said suitable storage location;
wherein an estimated storage life of said suitable storage location accommodates said expiry date.

2. The method of claim 1, wherein the storage space is cloud storage space with disks of a plurality of storage technologies including racetrack (RT), phase change (PC), solid state disk (SDD) and hard disk drive (HDD).

3. The method of claim 1, wherein the estimated storage life extends beyond said expiry date.

4. The method of claim 1, further comprising:
calculate a priority value for said immutable file, said priority value being used to determine the suitable storage location.

5. The method of claim 4, wherein said suitable storage location is one of a plurality of storage locations determined to be suitable, the method further comprising:
using the priority value to select said suitable storage location from among the plurality of storage locations determined to be suitable.

6. The method of claim 4, wherein said suitable storage location is determined to be most cost effective among the plurality of storage locations determined to be suitable.

7. The method of claim 1, wherein the immutable file is detected in response to being marked as immutable.

8. The method of claim 1, wherein the immutable file is detected in response to an audit of existing files.

9. The method of claim 1, wherein said suitable storage location is a first suitable storage location, the method further comprising:
store a copy of the immutable file in a second suitable storage location.

10. The method of claim 1, further comprising:
maintain a list of available cloud storage locations, said list specifying a memory technology and an expected end of life for each disk in the available cloud storage locations.

11. A software product comprising a machine readable medium including a program of instructions for storing an immutable file, wherein the program of instructions upon being executed on a computer causes the computer to perform activities comprising:
detecting the immutable file;
determining an expiry date of said immutable file;
analyzing available storage space to determine a suitable storage location; and
storing the immutable file in said suitable storage location;
wherein an estimated storage life of said suitable storage location accommodates said expiry date.

12. The software product of claim 11, wherein the storage space is cloud storage space with disks of a plurality of storage technologies including racetrack (RT), phase change (PC), solid state disk (SDD) and hard disk drive (HDD).

13. The software product of claim 11, wherein the estimated storage life extends beyond said expiry date.

14. The software product of claim 11, wherein the activities further comprise:
calculating a priority value for said immutable file, said priority value being used to determine the suitable storage location.

15. The software product of claim 14, wherein said suitable storage location is one of a plurality of storage locations determined to be suitable, the method further comprising:
using the priority value to select said suitable storage location from among the plurality of storage locations determined to be suitable.

16. The software product of claim 14, wherein said suitable storage location is determined to be most cost effective among the plurality of storage locations determined to be suitable.

17. The software product of claim 11, wherein the immutable file is detected in response to being marked as immutable.

18. The software product of claim 11, wherein the immutable file is detected in response to an audit of existing files.

19. The software product of claim 11, wherein said suitable storage location is a first suitable storage location, wherein the activities further comprise:
storing a copy of the immutable file in a second suitable storage location.

20. The software product of claim 11, wherein the activities further comprise:
maintaining a list of available cloud storage locations, said list specifying a memory technology and an expected end of life for each disk in the available cloud storage locations.

21. A system configured to store an immutable file, the system comprising:
a network interface device configured to receive an indication of immutable status of the immutable file, wherein said immutable file is characterized by an expiry date;
a processor configure to execute instructions for analyzing available storage space to determine a suitable storage location; and
a memory configured to store information associated with said suitable storage location;
wherein an estimated storage life of said suitable storage location accommodates said expiry date.

22. They system of claim 21, wherein the storage space is cloud storage space with disks of a plurality of storage technologies including racetrack (RT), phase change (PC), solid state disk (SDD) and hard disk drive (HDD).

23. The system of claim 21 wherein said memory is configured to maintain a list of available cloud storage locations, said list specifying a memory technology and an expected end of life for each disk in the available cloud storage locations.
